(19) United States
(12) Patent Application Publication
(10) Pub. No.: US 2007/0070063 A1
(43) Pub. Date: Mar. 29, 2007

(54) Non-photorealistic volume rendering of ultrasonic data

(75) Inventor: Thilaka S. Sumanaweera, Los Altos, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/241,640

(22) Filed: Sep. 29, 2005

(51) Int. Cl. G06T 15/00

(52) U.S. Cl. 345/419

(57) ABSTRACT

A non-photorealistic image of a volume is rendered with ultrasound data as a function of a geometric primitive. A geometric primitive is identified and geometric primitive information is used for ultrasound image processing. The image is created such that each pixel in the image is one of a limited number of labels, such as two or three, based on the geometric primitive information for each pixel. The non-photorealistic image is created such that each label represents a pixel of an image wherein each pixel is one of a limited number of colors depending on the value of the label

### BACKGROUND

The present disclosure relates to rendering a non-photorealistic image based on ultrasound data.

Volume rendering generates two-dimensional images from three-dimensional data volumes. MRI, CT and ultrasound use volume rendering for three-dimensional imaging. Photo-realistic volume rendering of ultrasonic data is the method of choice for producing 2D images on computer monitors for visualizing 3D and 4D ultrasound images. Photo-realism is the effect achieved by modeling the interaction of light with the ultrasound data when volume rendering. Optical effects such as emission, absorption, reflection, scattering or shadowing are modeled in photo-realistic volume rendering. Such photo-realistic models can also model scattering and occlusion (shadow casting) of light, producing “realistic” looking images. Typically, shading of ultrasound images is based on 256 colors for each pixel within an image.

The goal of these techniques is to create visual effects that mimic objects illuminated by light in the physical world, however “realistic” images are not always aesthetically pleasing. “Realistic” images appear very clinical and may reveal more detail than is necessary.

It is desirable to obtain aesthetically pleasing images that result from an ultrasound scan, particularly in the case of a parent viewing an image of a baby in the womb. Ultrasound images, particularly photo-realistic images, tend to be very clinical and not visually pleasing for the untrained eye.

### BRIEF SUMMARY

By way of introduction, the preferred embodiments described below include methods, systems and computer readable media for rendering an image with ultrasound data as a function of a geometric primitive such as a three-dimensional point, a curve, or a surface. A geometric primitive is identified using a processor and the geometric primitive information is used for ultrasound image processing. The image is created such that each pixel in the image is one of a limited number of labels based on the geometric primitive information for each pixel. In one embodiment, a non-photorealistic image is created such that each pixel of the image wherein each pixel is either black or white depending on the value of the corresponding data or label. Non-photorealistic volume rendering can produce images that are more like an artistic rendering or an illustration.

In a first aspect, a method is provided for rendering an image with ultrasound data. A geometric primitive is identified from ultrasound data representing a volume. One of three or fewer labels are assigned to each of a plurality of locations on the geometric primitive and an image is generated as a function of the assigned labels.

In a second aspect, a system is provided for rendering an image with ultrasound data. A processor is operable to identify a geometric primitive from the ultrasound data. A memory is operable to store the ultrasound data representing a plurality of scan lines spaced through a volume and pixels in a display are assigned one of three or fewer labels based on the ultrasound data.

In a third aspect, a computer readable storage medium includes instructions executable by a programmed processor for rendering an image based on ultrasound data. The instructions identify a geometric primitive from the ultrasound data representing a volume and display the image with each pixel being one of three or fewer values as a function of the geometric primitive.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being place upon illustrating the principles of the invention.

FIG. 1 is a block diagram of one embodiment of an ultrasound system;

FIG. 2 is a block diagram of an alternate embodiment of an ultrasound system;

FIG. 3 is a flowchart diagram of one embodiment of a general method for creating a non-photorealistic volume rendering ultrasound data;

FIG. 4 is a flowchart diagram of one embodiment of a specific method for creating a non-photorealistic volume rendering of ultrasonic data; and

FIG. 5 is a graphical representation of a non-photorealistic volume rendering of ultrasonic data.

### DETAILED DESCRIPTION OF THE DRAWINGS AND THE PRESENTLY PREFERRED EMBODIMENTS

Non-photorealistic images are 2D illustrations derived from 3D or 4D real-time ultrasonic data. The images appear to have been produced by pen strokes of an illustrator or an artistic rendering rather than a clinical, or “realistic,” ultrasound image using optical models. Non-photorealistic volume rendering is accomplished by using a model where no or little interaction of light and matter is modeled. The illustration-like effect can be produced many ways as will be discussed below.

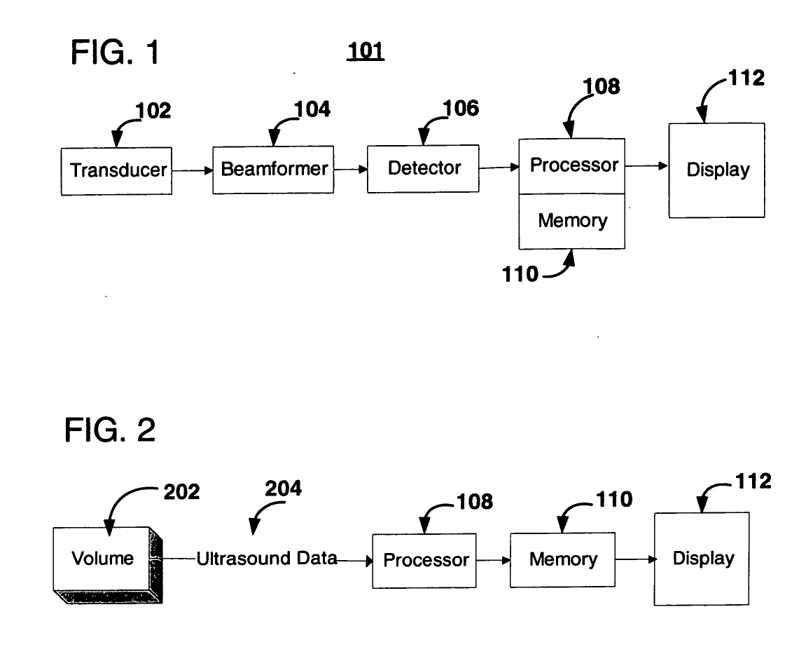

FIG. 1 shows the ultrasound system 101 for creating non-photorealistic images from ultrasound data. The ultrasound system 101 includes a transducer 102, a beamformer 104, a detector 106, a processor 108 with a memory 110, and a display 112. Additional, different or fewer components may be provided. For example, the processor 108 may be either a Computer Processing Unit (CPU) or a Graphics Procession Unit (GPU) and the memory 110 may be combined with the processor 108 as a single unit. The processor 108 configures the system 101, determines a geometric primitive parameter, processes ultrasound data based on geometric primitive parameters or performs other functions. In an alternative embodiment, the system 101 is a workstation or computer operable on ultrasound data obtained with another device.

The transducer 102 is a 1, 1.25, 1.5, 1.75, or two-dimensional array of elements. The array of elements is configured for linear, curvilinear, sector, Vector®, or other imaging configurations. Electrical and/or mechanical steering is provided. The beamformer 104 connects with the transducer 102 for generating acoustic beams along an acoustic grid. For example, a polar coordinate format is used in a two-dimensional plane or a three-dimensional volume to acquire signals representing range samples along scan lines. The acoustic data is collected by rocking, rotating, or sliding the transducers with mechanical movement or using electronic beam steering. In alternative embodiments, a cylindrical grid, Cartesian grid, hexagonal grid or other coordinate system is used. Where the sampling is along a Cartesian grid, such as using a linear array, the sampling is likely on a larger scale or with a different resolution than the display Cartesian grid. As a result, scan conversion is typically performed on such data, but may be minimized or eliminated using the processes described herein.

The detector 106 is a B-mode, Doppler, flow and/or other detector for identifying intensity, energy, velocity or other information from the beamformer signals. The ultrasound data may be any one of B-mode, Doppler velocity information, or Doppler energy information.

The system 101 may contain an optional scan converter (not shown) that converts from the acoustic grid to a Cartesian coordinate grid, such as associated with the display 24. In embodiments where some data is formatted in a Cartesian coordinate system, a scan converter converts some data from the acoustic grid to the Cartesian coordinate grid. For example, a scan-converter scan-converts a plurality of two-dimensional images or planes from an acoustic grid to a Cartesian coordinate grid. Alternatively, a scan converter, CPU, GPU or other processor converts some or all of the acoustic grid data to a 3D Cartesian grid.

The memory 110 may comprise a video random access memory, a random access memory, or other memory device for storing data or video information. The memory 110 may be a computer-readable storage media or memory, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, filmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

In one embodiment, the memory 110 comprises a video random access memory of the processor 108. In alternative embodiments, the memory 110 is separate from the processor 108, such as a cache memory of a processor, the system memory or other memory. The memory 110 is operable to store ultrasound data formatted in an acoustic grid, a Cartesian grid, both a Cartesian coordinate grid and an acoustic grid, or ultrasound data representing a volume in a 3D grid.

In one embodiment, the processor 108 may be a GPU which comprises a graphics accelerator chip, processor, applications specific integrated circuit, circuit, or accelerator card. In a second embodiment, the processor 108 is a personal computer graphics accelerator card or components, such as manufactured by nVidia (e.g. Quadro4 900XGL or others), ATI (e.g. Radeon 9700 or others), or Matrox (e.g. Parhelia or others). The processor 108 provides hardware devices for accelerating the volume rendering processes, such as using application programming interfaces for three-dimensional texture mapping. Example APIs include OpenGL and DirectX, but other APIs may be used independent of or with the processor 108. The processor 108 is operable to texture map with alpha testing or other volume rendering of the ultrasound data based on a spatial relationship of an intersection relative to the viewing direction with an acoustic grid or data space.

The processor 108 and/or the memory 110 may be included within the system 101 as part of a single ultrasound system component, such as an ultrasound system on a cart in a same housing. In alternative embodiments, the processor 108 and memory 110 are provided separate from an ultrasound data acquisition system, such as provided in a workstation or personal computer as shown in FIG. 2. The ultrasound data may be transferred wirelessly, over a computer network or through a transferable storage medium to the processor 108.

The display 24 is a CRT, LCD, flat panel, plasma screen, video projector or other device for displaying a two-dimensional image of a three-dimensional volume or representation. For example, the display 24 may be a color display capable of a 512×512 pixel area, or greater or lesser resolutions. The display 24 is a color display, but monochrome displays may be used.

The display 24 comprises a plurality of pixels, wherein each pixel for an image is assigned one of three or fewer labels (also referred to as amplitudes or values) based on the ultrasound data. The labels represent a particular color for each pixel. In one embodiment, the display 24 is operable to display individual pixels of either two or three different colors or shades of the same color. In an alternate embodiment, the label or value of each pixel can represent one of a finite set of colors. For example, the finite set of colors comprises black and white, and therefore each pixel could be either black or white. In one embodiment, the display 24 uses pixels that are either black, white, or gray to create the non-photorealistic image. In this embodiment, each pixel is assigned a label representing either black, white, or gray. The non-photorealistic image created in this embodiment contains pixels that are all either black, white, or gray. Alternatively, the pixels may be labeled using a more abstract labeling scheme, such as assigning different ‘enum’ tags as defined in C/C++ language specification.

FIG. 2 is an alternate embodiment of an ultrasound system. A processor 108, memory 110, and display 112 are shown. The processor 108 receives ultrasound data 204 representative of a volume 202 from storage or a separate imaging system. Ultrasound images of the volume 202 are shown on the display 112. In this embodiment, the processor 108 and the memory 110 are separate components, but may be located in the same housing. As discussed above, the processor 108 is operable to identify a geometric primitive from the ultrasound data 204 wherein the geometric primitive is representative of the volume 202. The memory 110 is operable to store ultrasound data representing a plurality of scan lines spaced through the volume 202. The ultrasound data stored in memory 110 may be the raw ultrasound data 204, or it may be processed data from the processor 108, after the processor 108 processes the ultrasound data 204.

The processor 108 identifies a geometric primitive by casting rays into the volume 202 so that the volume 202 may be represented by that geometric primitive. Rays cast into the volume 202 each correspond to one of a plurality of pixels in the display 112.

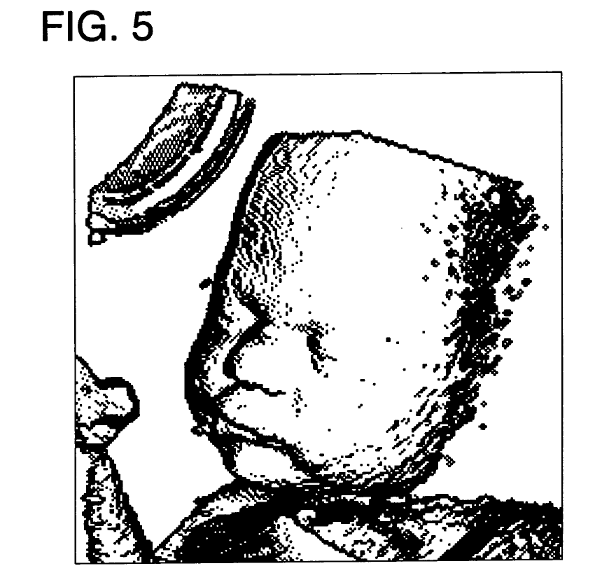

The volume 202 may be any object from which ultrasound data 204 is taken. Medical imaging is a common use for ultrasound to develop images of various parts of the human body. Non-photorealistic imaging can be used for the imaging of an unborn baby. Parents can view a non-photorealistic image of their baby, such as in FIG. 5. However, non-photorealistic imaging can also be used for other applications, such as diagnosis.

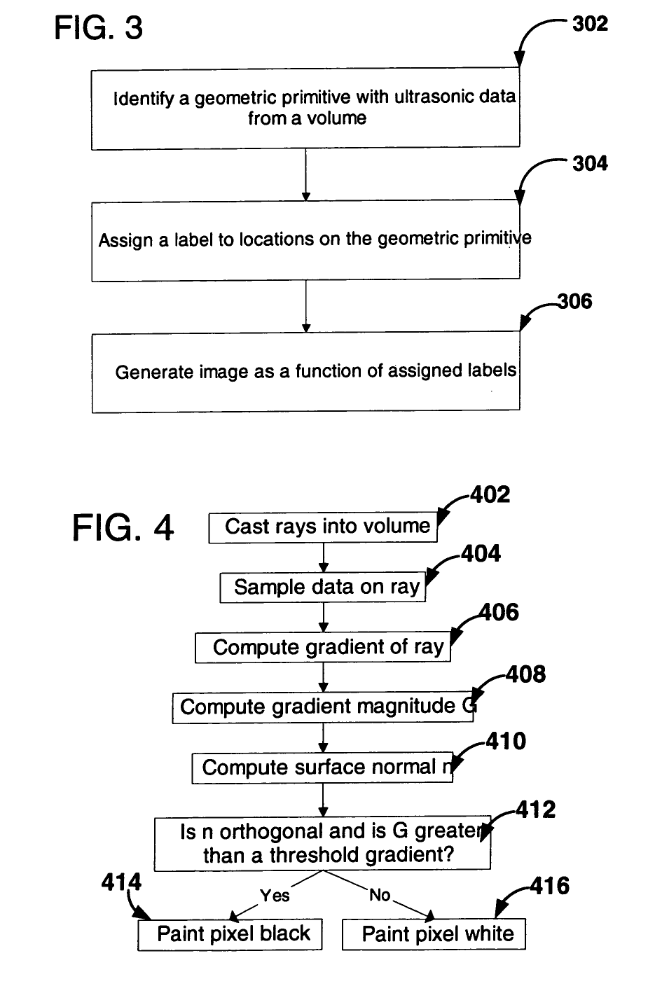

FIG. 3 shows a flow chart for a method of producing a non-photorealistic image from ultrasound data. The method is implemented on the systems of FIG. 1 or FIG. 2 or on a different system. For example, the system disclosed in U.S. Pat. No. ______, (Publication No. ______ (application Ser. No. ______ (Attorney Docket No. 2005P06118US))), the disclosure of which is incorporated herein by reference, is used. Additional, different, or fewer acts may be provided. FIG. 4 shows one embodiment of the method from FIG. 3 in which a non-photorealistic image is created. In this embodiment, one of two labels are assigned to a location on the geometric primitive. The first label represents black and the second label represents white, so that each pixel of the image is either black or white. Other colors or binary representations may be used.

In act 302 of FIG. 3, a geometric primitive is identified in a volume, which is subject to an ultrasound scan. The ultrasound data is representative of that geometric primitive. The geometric primitive of a volume may be identified by casting rays into the volume and identifying a geometric primitive characteristic, such as data above a threshold, or data associated with a sufficient gradient or derivative. Other now known or later developed geometric primitive identification techniques, such as associated with geometric primitive rendering, may be used. Each ray corresponds to one of a plurality of locations on the geometric primitive, and ultrasound data is extracted from each of the rays to select data for the entire geometric primitive.

One method for processing ultrasound data as a function of a geometric primitive involves using a GPU for determining surface parameters. In one embodiment, the geometric primitive detected is a surface. Ultrasound data is processed to populate a frame buffer. For example, frames of data representing different intersections with a volume are composted in the frame buffer. The ultrasound data is sent to a GPU or CPU for processing and data associated with a plurality of intersections with the volume are selected for compositing. The intersections are parallel planes, spherical surfaces or others. For example, a plurality of parallel planes orthogonal to a viewing direction is used for selecting data for rendering.

Ultrasound data may be used to populate a depth buffer. For example, the method disclosed in U.S. Pat. No. ______, (Publication No. ______ (application Ser. No. 11/157,412 (Attorney Docket No. 2005P06118US) (filed on Jun. 20, 2005))), the disclosure of which is incorporated herein by reference, for identifying a is used. As the frame buffer is populated, ultrasound data associated with a series of substantially parallel geometric primitives is examined. If the ultrasound data associated with a given pixel or location in the depth buffer is closer to the viewer and above a threshold, the depth or coordinate of the data is written to the depth buffer. The closer depth overwrites data along the same ray line but at a deeper depth. Each pixel in the depth buffer is a number or coordinate of the depth of the pixel in the screen coordinate system. For data representing a volume, the populated depth buffer contains the distances of the voxels larger than T and closest to the screen. One depth value is provided for each 2D location in the depth buffer. The depth buffer contains the (x, y, z) screen-coordinates of the iso-surface corresponding to the iso-value T. The 2D depth buffer indicates a surface associated with the closest values to a viewer that are above a threshold.

In one embodiment, the rendering is based on intersections arranged relative to a target structure or likely surface rather than parallel planes orthogonal to the viewing direction. The depth buffer is populated with the coordinates of data closest to a center of the target surface and greater than a threshold.

Surface information is derived from the data from the depth buffer. The coordinates or depths stored for a given viewing direction are processed or read back. Any one or more surface parameters are detected. For each or selected spatial locations in the depth buffer, a surface normal, surface tangent, surface coordinates, principal curvature direction (major or minor), Gaussian curvature, combinations thereof or other surface parameter are detected. Other surface information includes an orientation of the surface relative to an insonification angle. For example, the difference between a surface normal vector and an insonification angle is calculated. Alternatively, the gradient normal, principle curvature directions or Gaussian curvature, combinations thereof or other geometric primitive parameters could be derived directly from the ultrasound data, rather than detecting a geometric primitive such as a surface first.

An embodiment of act 302 is shown in FIG. 4. In act 402, rays are cast into a volume as described above. In act 404, data is sampled from the rays cast into the volume. Data can be sampled from each ray until an intensity along the ray is larger than a threshold intensity. The threshold intensity is determined by the user, predetermined, or adapted, and affects the sensitivity of the ultrasound data. The intensity threshold is used to determine the location in the volume of the geometric primitive closest to a virtual view for each ray. The identified intensity represents the geometric primitive at that location.

Referring to FIG. 3, in act 304, a label or value is assigned to the plurality of locations on the geometric primitive. Each location may be assigned a label from a finite set of labels. In one embodiment, three or fewer labels can be assigned. The assignment of one label for each location is done as a function of a geometric primitive parameter. The geometric primitive parameter may be a value of data or echo intensity at the geometric primitive, a gradient characteristic of the ray, or whether the ray is orthogonal. The geometric primitive parameter used for the assignment of labels may be based on other calculations or measurements of the geometric primitive.

FIG. 4 shows one embodiment of the assignment of labels to locations on a surface, which is a type of geometric primitive. In act 406, spatial gradients are computed along the range, azimuth and elevation direction: [Gx Gy Gz] for the surface. The computation of the spatial gradients is at or for the surface. Alternatively, 2D spatial gradients [Dx, Dy] of the data in the depth buffer are computed. The spatial gradients are determined using any now known or later developed approach, such as computing a central difference. Any size sampling window for computing the spatial gradients may be used, such as a 2, 3 or greater number of pixels in a symmetrical or asymmetrical sampling window.

In act 408, the gradient magnitude G is computed such that G=sqrt(Gx²+Gy²+Gz²). The gradient magnitude G can be interpreted as a representation of the intensity of the gradient at a point in the volume.

In act 410, the surface normal n at each location is computed. To compute the normal, the spatial gradients are used. The vector, n, is computed in the acoustic domain by normalizing [Gx, Gy, Gz]. Other surface normal calculations may be used. In another embodiment, the 3D surface normal is computed for each spatial location of the 2D depth buffer. The surface normal is given by: n=[Dx Dy 1.0]/sqrt(1.0+Dx²+Dy²), but other equations may be used. The determination of the spatial gradients and normal vector are performed in yet another pass through the GPU in one embodiment. Alternatively, the filtering, gradient determination and normal calculation are performed in one pass though the GPU or by a processor not in the GPU.

In act 412, two determinations are made. First, the gradient magnitude is compared with a gradient threshold. Second, a determination is made as to whether the surface normal n is substantially orthogonal to the viewing direction of the image or within a range of being orthogonal to the viewing direction. If the surface normal n is orthogonal or substantially orthogonal to the viewing direction and the gradient magnitude G is greater than a threshold gradient, then the corresponding pixel is mapped to black according to act 414. Conversely, if either the surface normal n is not orthogonal to the viewing direction or the gradient magnitude G is less than the threshold gradient, then the corresponding pixel is mapped to white according to act 416.

The determination regarding whether the surface normal n is orthogonal or substantially orthogonal to the viewing direction can be done as follows. If the unit vector, v, defines the viewing direction, the dot product, d=v·n is first computed. If d or some function of d is greater than a lower threshold d_{low} and smaller than a higher threshold, d_{high}, the location on the surface passes the test. Different determination schemes can also be used. Like the gradient threshold, the surface normal threshold value can determine a range of values for which the determination will be satisfied.

The determinations made in act 412 are just two possibilities of calculations that may be used to distinguish between the labels for individual pixels in creating a non-photorealistic image. Either determination independently may be used or in combination with other determinations. Surface curvatures of the 2nd or 3rd order can be computed. Gradient calculations to the 2nd or 3rd order result in a different set of determinations and a different resulting image. Any process could be used as a determination that detects the borders from a 3D surface.

Each ray represents a location on the geometric primitive, and the locations then correspond to individual pixels on a display or image. Interpolation, extrapolation, or filtering may be used where there are fewer data locations than image pixels. In FIG. 3, act 306, an image is generated as a function of the assigned labels for each location. The image is created by using one of a finite number of labels and mapping colors, hues, brightness, and/or shades for each pixel of the image. In one embodiment three colors, such as black, white, and gray, are used for the pixels of the image. An image where each pixel is assigned one of a low, finite number of colors gives the non-photorealistic look shown in FIG. 5.

In one embodiment in FIG. 4, acts 414 and 416, two colors, such as black and white, are used for the pixels of an image. The greater the gradient threshold, the more white pixels will result because fewer rays will satisfy the threshold gradient. Conversely, a smaller gradient threshold results in more black pixels and produces an image that will likewise appear to be darker because of the increased number of black pixels. The gradient magnitude G also helps to reduce the noise in the ultrasound data.

In an alternative embodiment, the non-photorealistic image is combined with a second image. For example, a photorealistic image is combined with a non-photorealistic image or rendering of the same volume. Any combination may be used, such as averaging, weighted averaging, linear or non-linear. The combination of a non-photorealistic image with a second image creates an alternate image that may maintain the realism of a photo-realistic image, but still possess the artistic value of non-photorealistic images.

A resulting image from the binary method described in FIG. 4 is the image shown in FIG. 5. In the case where there are three labels or colors to choose from rather than two as in FIG. 4, then two threshold gradients can be used to differentiate between the three colors. One scenario with three colors would have a pixel colored black if the surface normal n is orthogonal or substantially parallel to the viewing direction, and the gradient magnitude G is greater than a first threshold gradient. A pixel would be colored gray if the surface normal n is orthogonal or substantially parallel to the viewing direction, and the gradient magnitude G is greater than a second threshold gradient but less than a first threshold gradient. The first threshold gradient is higher than the second threshold gradient. Finally, a pixel would be white if either the surface normal n is not orthogonal to the viewing direction or the gradient magnitude G is less than the second threshold gradient. Alternatively, just the normal threshold or both the normal and gradient magnitude thresholds vary.

It is therefore intended that the foregoing detailed description be regarded as illustrative rather than limiting, and that it be understood that it is the following claims, including all equivalents, that are intended to define the spirit and scope of this invention.

1. A method for rendering an image with ultrasonic data, the method comprising:
identifying a geometric primitive from the ultrasound data representing a volume;
assigning one of three or fewer labels to each of a plurality of locations on the geometric primitive; and
generating the image as a function of the assigned labels.

2. The method of claim 1 wherein the geometric primitive is the surface of the volume.

3. The method of claim 1 wherein the step of identifying a geometric primitive comprises casting rays into the volume wherein each ray corresponds to one of the plurality of locations on the geometric primitive and extracting ultrasound data from each of the rays.

4. The method of claim 1 wherein the assignment of the one of three or fewer labels is a function of a geometric primitive parameter.

5. The method of claim 4 wherein the geometric primitive parameter comprises a direction of an orthogonal vector, a gradient characteristic, or a combination thereof.

6. The method of claim 5 wherein the gradient characteristic satisfies a gradient magnitude.

7. The method of claim 5 wherein the direction of the orthogonal vector is determined based on whether a geometric primitive normal is substantially parallel with the viewing direction.

8. The method of claim 1 wherein the ultrasound data is one of B-mode, Doppler velocity information, or Doppler energy information.

9. The method of claim 1 wherein the three or fewer labels comprises two labels wherein each of the two labels represents either black or white and each pixel of the image is either black or white.

10. The method of claim 1 wherein each one of three or fewer labels comprise one of the colors black, white, and gray, wherein each of the one of three or fewer labels are different.

11. The method of claim 1 further comprising:
combining the image with a second image, wherein the second image is a representation of the volume.

12. The method of claim 1 further comprising:
assigning one label to each location where a geometric primitive normal is substantially parallel to the viewing direction and a gradient characteristic satisfies a gradient magnitude.

13. A system for rendering an image with ultrasound data, the system comprising:
a processor operable to identify a geometric primitive from the ultrasound data wherein the geometric primitive represents a volume;
memory operable to store the ultrasound data representing a plurality of scan lines spaced through the volume;
a display comprising a plurality of pixels, wherein each of the plurality of pixels is assigned one of three or fewer labels based on the ultrasound data.

14. The system of claim 13 wherein the assignment of the one of three or fewer labels is based on a whether a geometric primitive parameter is satisfied.

15. The system of claim 13 wherein the processor identifies a geometric primitive by casting rays into the volume wherein each ray corresponds to one of the plurality of pixels.

16. The system of claim 15 wherein the geometric primitive parameter for each ray comprises a direction of an orthogonal vector, a gradient characteristic, or a combination thereof.

17. The system of claim 16 wherein the gradient characteristic satisfies a gradient magnitude.

18. The system of claim 16 wherein the direction of an orthogonal vector is determined based on whether a geometric primitive normal is substantially parallel with the viewing direction.

19. The system of claim 13 wherein the ultrasound data is one of B-mode, Doppler velocity information, or Doppler energy information.

20. The system of claim 13 wherein each one of the three or fewer labels comprises one of black, white, or gray, wherein each of the one of three or fewer labels are different.

21. In a computer readable storage medium having stored therein data representing instructions executable by a programmed processor for rendering an image based on ultrasound data, the storage medium comprising instructions for:
identifying a surface from the ultrasound data representing a volume;
displaying the image with each pixel being one of three or fewer values as a function of the surface.

22. The instructions of claim 21 wherein the step of identifying a surface comprises casting rays into the volume wherein each ray corresponds to one of the plurality of positions on the surface; and extracting ultrasound data from each of the rays.

23. The instructions of claim 21 wherein the assignment of the one of three or fewer values is based on a whether a surface parameter is satisfied.

24. The instructions of claim 23 wherein the surface parameter comprises a direction of the orthogonal vector, a gradient characteristic, or a combination thereof.

25. The instructions of claim 24 wherein the gradient characteristic is a gradient magnitude.

26. The instructions of claim 24 wherein the orthogonal vector is determined based on whether a surface normal is substantially parallel to the viewing direction.

27. The instructions of claim 21 wherein the ultrasound data is one of B-mode, Doppler velocity information, or Doppler energy information.

28. The instructions of claim 21 wherein each one of the three or fewer values represents one of black, white, or gray, wherein each one of the three or fewer values are different.

29. The instructions of claim 21 wherein the three or fewer values comprises two values wherein each of the two values represent either black or white, wherein each pixel is either black or white.
